(19) United States
(12) Patent Application Publication
(10) Pub. No.: US 2008/0066370 A1
(43) Pub. Date: Mar. 20, 2008

(54) Fish hook with two eyelets

(76) Inventor: Dennis Anthony Wichern, Carmel, IN (US)

Correspondence Address: Dennis Anthony Wichern, 12437 Meeting House Road, Carmel, IN, 46032, US

(21) Appl. No.: 11/728,529

(22) Filed: Mar. 26, 2007

Related U.S. Application Data
(60) Provisional application No. 60/845,391, filed on Sep. 18, 2006.

(51) Int. Cl. A01K 83/00

(52) U.S. Cl. 43/44.83; 43/43.16; 43/44.82

(57) ABSTRACT

An improved fish hook with two eyelets to be used for fishing. A primary eyelet located at the top of the fish hook and a secondary eyelet located at the bottom. The primary eyelet would generally be affixed to a fishing lure or line while the secondary eyelet could have various appendages attached by split ring and or swivels, much like a vehicle with a trailer hitch can connect to various trailers. Attached appendages would consist of but not be limited to metal or synthetic blades commonly referred to as “Willow Leaf”, “Colorado” and “Indiana” forms, additional fishing hooks or hook, fishing line, barbed shafts or shaft and various plastic imitation baits such as crawfish, grubs, worms and minnows.

### CROSS REFERENCE TO RELATED APPLICATIONS

Design application #29/273134 dated Feb. 27, 2007.

Provisional application No. 60/845,391 dated Sep. 18, 2006.

Design application #29/265974 dated Sep. 12, 2006.

Document Disclosure #605789 dated Sep. 8, 2006.

### STATEMENT REGARDING FEDERALLY SPONSORED RESEARCH AND DEVELOPMENT

Not applicable.

### REFERENCE TO SEQUENCE LISTING, A TABLE, OR A COMPUTER PROGRAM LISTING COMPACT DISC APPENDIX

Not applicable.

### BACKGROUND OF THE INVENTION

1. Field of the Invention

The present invention relates to an improved fish hook, comprised of one, two or three barbed fishing hook(s) fold molded, fused, or soldered together at the shank with a connecting ring formed at the top.

2. Description of Related Art

The fish hook and the treble fish hook are some of the oldest fish catching tools known to man. Generally, fish hooks are comprised of a shank, barbed point or points and one connecting ring or eyelet which is typically connected to a fishing lure or line.

The prior art does not teach of a fish hook or treble fish hook which utilizes two eyelets. A primary eyelet for attachment to a fishing lure or line and a secondary eyelet, located at the bottom of the shank, to be used for other attachments or appendages, much like a vehicle with trailer hitch has the ability to connect to various trailers. Thus, there is need for a fish hook and treble fish hook with two eyelets which gives the angler the ability to customize his or her hooks.

### BRIEF SUMMARY OF THE INVENTION

It is the object of the present invention to provide an improved fish hook with two eyelets, a primary eyelet located at the top of the shank and a secondary eyelet located at the bottom of the shank, applicable to single, double and treble fish hooks which provides the angler the option to customize his or her hooks by connecting various appendages. The top or primary eyelet would generally be affixed to a fishing lure or line while the secondary or bottom eyelet could have various appendages attached by split ring and or swivels, much like a vehicle with a trailer hitch can connect to various trailers. Attached appendages would consist of but not be limited to metal or synthetic blades commonly referred to as “Willow Leaf”, “Colorado” and “Indiana” forms, additional fishing hooks or hook, fishing line, barbed shafts or shaft and various plastic imitation baits such as crawfish, grubs, worms and minnows.

The advantage to this invention is that it allows the angler the ability to customize his or her fishing lures and hooks for every type of fishing situation since the majority of fishing lures use either hooks or treble hooks. Most fishing lures are referred to as crankbaits, stickbaits, spinnerbaits and plastics and each has its own attributes, yet most have not been combined. Most crankbaits and stickbaits have one to three sets of attached treble hooks and are manufactured in numerous sizes, shapes and color combinations. Spinnerbaits come in a variety of colors and have at least one or more spinning metal blades. These blades vibrate and reflect light which mimic bait fish movement. Imitation plastics lures usually take the form of worms, single or double-tail grubs, minnows, crawdads, frogs, salamanders, etc and often feel and look similar to the bait they imitate.

Each of the aforementioned types of fishing lures is effective depending upon conditions. The current invention allows the angler to customize his or her treble hooks by simply adding the needed appendage to the secondary or bottom eyelet of the treble hook. For example, minnow looking crankbaits are effective but do not have the light reflective characteristics of a spinnerbait because the crankbait lacks a reflective blade. With this invention a blade or other appendage can be attached to the secondary eyelet of the treble hook by simply connecting the blade or other appendage by a split ring or swivel.

The addition of imitation plastic bait is just as simple. For example, a single barb hook is ran through a single tail grub and then affixed to the secondary eyelet of the treble hook of a crankbait giving the appearance of a lateral moving fin. The current invention also allows the angler to customize his or her fish hooks by simply adding the needed appendage to the secondary or bottom eyelet of the fish hook. For example, an angler can connect fish hooks together by line so that he can present multiple hooks with attached bait at different depths.

### BRIEF DESCRIPTION OF THE SEVERAL VIEWS OF THE DRAWINGS

FIG. 1 is a perspective view of the fish hook with two eyelets in treble hook form showing the invention design;

FIG. 2 is a side view thereof;

FIG. 3 is an opposite view thereof;

FIG. 4 is a front view thereof;

FIG. 5 is a rear view thereof;

FIG. 6 is a top plan view thereof; and,

FIG. 7 is a bottom view.

FIG. 8 is a schematic view of a fish lure showing one example of the state in which the invention design in treble hook form is actually used.

FIG. 9 is a perspective view of a fish hook with two eyelets in single hook form showing the invention design.

FIG. 10 is a side view of a fish hook with two eyelets in double hook form showing the invention design.

### DETAILED DESCRIPTION OF THE INVENTION

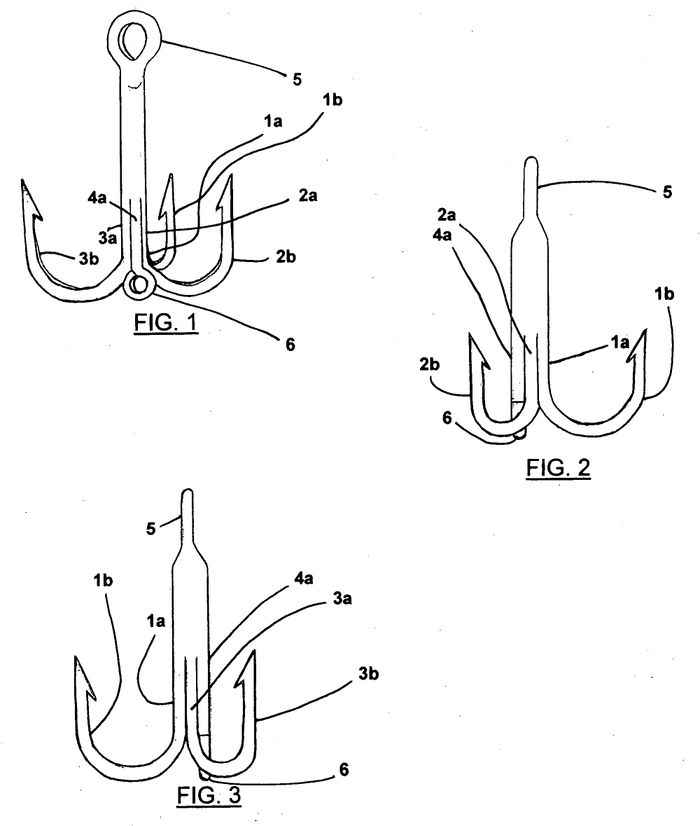

A more complete understanding of the invention may be obtained by reference to the accompanying drawings. Simply put, a secondary eyelet is added to the bottom shank of a conventional fish hook. In view of the prior art, the present invention has as its object to provide a fish hook with two eyelets, a primary eyelet at the top of the hook shank and a secondary eyelet at the bottom of the hook shank applicable to single, double and treble fish hooks. In order to achieve the above object, there is provided a treble fish hook, FIG. 1 in which barb-carrying bights 1b, 2b, and 3b, are equally spaced around an axis, and with shanks 1a, 2a, and 3a, and 4a, all of which are bundled together by soldering or fusing. A primary eyelet 5, is formed at the top of the treble hook and a secondary eyelet 6, is formed at the bottom.

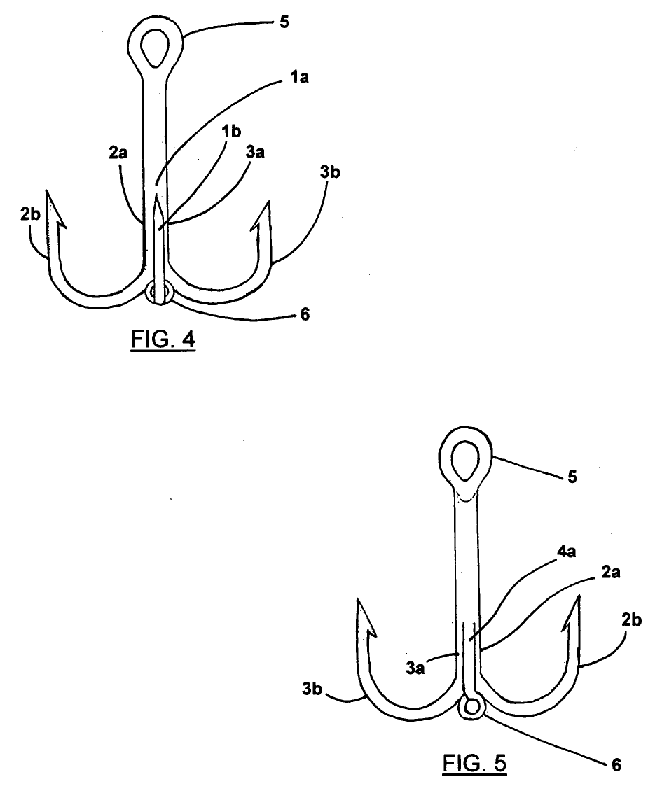

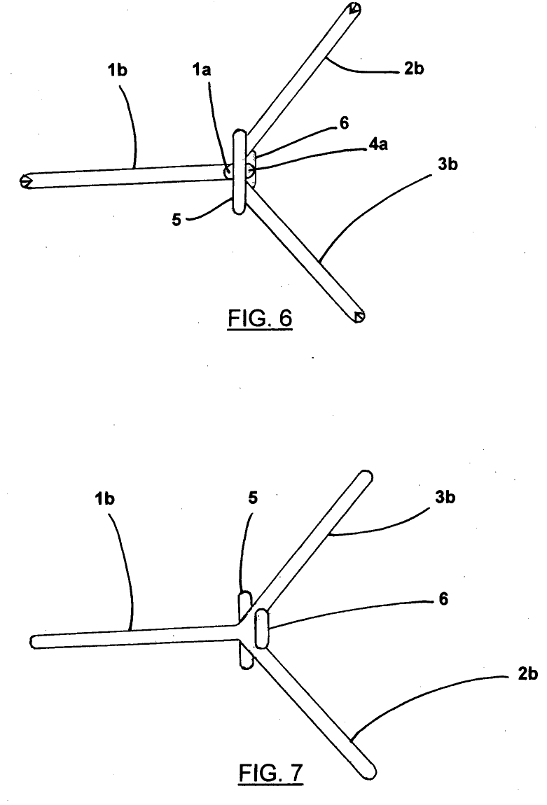

FIGS. 2 and 3 show side views of a treble fish hook embodying the invention. Barb carrying bights 1b and 2b along with bundled shanks 1a, 2a and 4a are displayed in FIG. 2 while barb carrying bights 1b and 3b and bundled shanks 1a, 3a and 4a are displayed in FIG. 3. FIG. 4 shows a front view of a treble fish hook embodying the invention. Barb carrying bights 1b and 2b along with 3b are merged into bundled shanks 1a, 2a and 3a. Also displayed are primary eyelet 5, and secondary eyelet 6. FIG. 5 shows a rear view of a treble fish hook embodying the invention. Barb carrying bights 3b and 2b are connected to bundled shanks 3a, 2a and 4a. Also displayed are primary eyelet 5, and shank 4a connected to secondary eyelet 6. FIGS. 6 and 7 show top and bottom views of the invention.

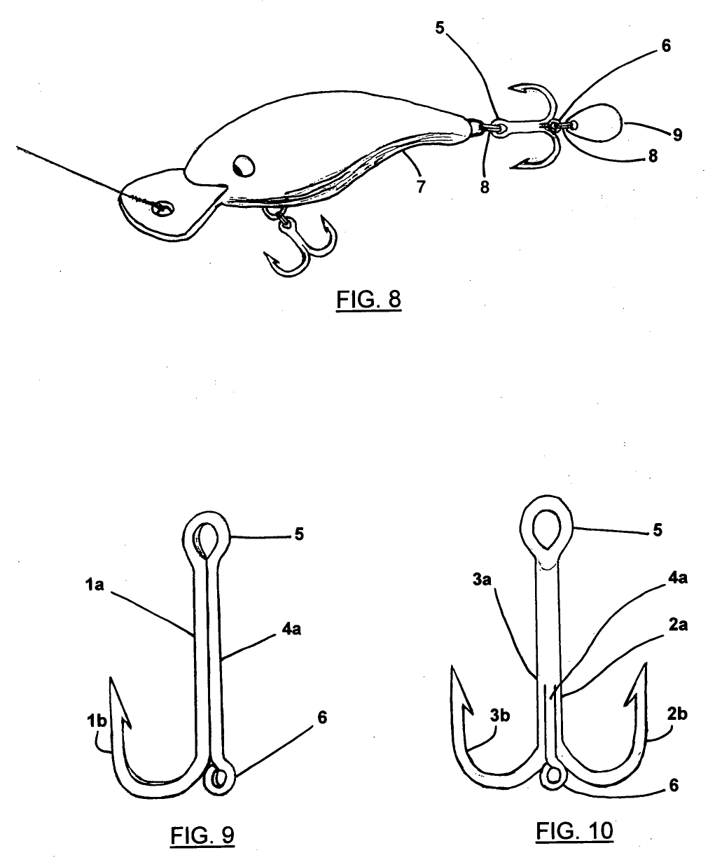

As shown in FIG. 8, a fishing lure 7, is outfitted with the preferred embodiment in treble hook form and connected to the rear of the lure by a split ring 8, through the primary eyelet 5. Attached to the preferred embodiment in treble hook form is one example of an appendage, a metal reflective blade 9, connected to the secondary eyelet 6, by a split ring, 8. FIG. 9 shows a single fish hook embodying the invention. The fish hook has a primary eyelet 5, connected to shanks 1a, and 4a. Shank 1a is merged into barb carrying bight 1b, and shank 4a is merged into secondary eyelet, 6. The fish hook may be soldered or fused at shanks 1a and 4a for added strength. FIG. 10 shows a double fish hook embodying the invention. The double fish hook has a primary eyelet 5, connected to shanks 2a, 3a and 4a. Shank 2a and 3a are merged to a barb carrying bight 2b and 3b, and shank 4a is merged into a secondary eyelet, 6.

It is to be understood that the form of the invention shown is a preferred embodiment thereof and that various changes and modifications may be made therein without departing from the spirit of the invention or scope as defined in the following claims.

What is claimed is:

1. An improved fish hook comprising:
(a) a primary eyelet for connection to fishing lure or line:
(b) a secondary eyelet for connection to various appendages; and
(c) an elongated shank having a first end and a second end; and a primary eyelet secured to the first end of the shank; and three barb-carrying bight portions secured to the second end of the shank, and a secondary eyelet attached to the shank located at the second end.

2. An improved fish hook as described in claim 1, wherein said fish hook has one barb-carrying bight portion secured to the second end of the shank, and a secondary eyelet attached to the shank located at the second end.

3. An improved fish hook as described in claim 1, wherein said fish hook has two barb-carrying bight portions secured to the second end of the shank, and a secondary eyelet attached to the shank located at the second end.
